(19) United States
(12) Patent Application Publication
(10) Pub. No.: US 2015/0209885 A1
(43) Pub. Date: Jul. 30, 2015

(54) APPARATUS AND METHOD FOR PROVIDING AN INERTING GAS DURING SOLDERING

(71) Applicant: Air Products and Chemicals, Inc., Allentown, PA (US)

(72) Inventors: Yark Zhang, Hubei Province (CN); Victor Wang, Guangzhou (CN); Jerry Wu, Shanghai (CN)

(21) Appl. No.: 14/607,757

(22) Filed: Jan. 28, 2015

(30) Foreign Application Priority Data
Jan. 29, 2014 (CN) 201410043162.3

(51) Int. Cl. B23K 3/06; B23K 1/20; B23K 35/362; B23K 3/08

(52) U.S. Cl. CPC B23K 3/0653; B23K 3/082; B23K 1/203; B23K 35/362

(57) ABSTRACT

Described herein is an apparatus and method for providing an inerting gas during the application of soldering to a work piece. In one aspect, there is provided an apparatus that is placed atop of a solder reservoir and comprises a plurality of porous diffuser tubes that are in fluid communication with an inerting gas. In another aspect, there is provided a method for providing an inerting gas to a wave soldering apparatus comprising the steps of, among other things, placing an apparatus atop at least one edge of the solder reservoir wherein the apparatus comprises a plurality of tubes comprising one or more openings in fluid communication with an inerting gas source. In a further aspect, at least one of the diffuser tubes comprises a porous protective sheath surrounding at least part of the length of the tube.

### BACKGROUND OF THE INVENTION

Described herein are an apparatus and a method for providing an inerting gas during soldering. More specifically, described herein are an apparatus and a method for providing an inerting gas during wave soldering using nitrogen and/or other inerting gas.

Work pieces such as printed wiring boards or circuit boards have increasingly smaller wettable surfaces that need to be solder coated and joined. Typical operations for wave soldering involve a soldering bath through which the printed circuit boards or work pieces to be soldered as transported. A conventional automatic wave soldering apparatus includes a flux application, a preheater, and a solder station that are arranged to process printed circuit boards. The printed circuit boards are transported along a moving track or conveyor with their side edges supported by gripping fingers. Flux may be applied by contacting the board with either a foam or spray of flux. The circuit board is then passed through a pre-heating area in order for the flux to reduce the oxides on the metal surfaces to be soldered. The circuit board is then contacted with single or multiple waves of molten solder in an air or in an inerting gas atmosphere.

The inerting gas atmosphere typically is nitrogen (N₂) and/or other inerting gases and is oftentimes called N₂ inerting. Soldering within an inert gas and/or nitrogen atmosphere minimizes the formation of dross or oxides on the surface of the solder. The presence of a dross and/or an oxide layer is known to cause skips, bridges, or other defects in solder joints. Proximal to the solder waves—which are produced by the wave soldering apparatus during operation—are porous pipes or tubes which run parallel to the solder wave and are used to transport the inerting gas and/or N₂ gas to provide a relatively low oxygen atmosphere, particularly underneath the work piece to be soldered.

For lead-free wave soldering, the value of an inerting gas atmosphere comprising N₂ is further increased due to the following reasons. The process temperature by using a common lead-free solder is significantly higher than that of conventional tin-lead solder due to the increased melting points of commonly used lead-free solders. The increase in process temperature promotes dross formation. Furthermore, the cost of a lead-free solder is normally much higher than that of the conventional tin-lead solder, and the economy loss associated with solder waste by dross formation is more significant than that of lead-free wave soldering. In addition, the wetting performance of a lead-free solder is intrinsically poor compared with that of the conventional tin-lead solder. Therefore, the quality of the formed solder joints is more sensitive to the state of oxidation on a lead-free solder surface.

It is well known that inerting in wave soldering can significantly reduce dross formation on the molten solder surface. Reducing dross formation not only saves solder material and lessens maintenance requirement, but also improves solder wetting and ensures the quality of the formed solder joints. To apply an inerting atmosphere in an existing wave soldering machine, one common approach is to insert into the molten solder reservoir a cage-like protective housing with diffusers mounted inside. An inerting gas blanket across the solder reservoir can be formed, thus, reducing the tendency of solder oxidation.

The diffusers are commonly made of porous tubes to introduce an inerting gas such as N₂ and/or other inerting gases into the soldering station. The porous tubes, however, become easily clogged by solder splashing or flux vapor condensation during the wave soldering process. Once the diffuser tube is clogged, the efficiency of inerting will be largely reduced. Present methods of cleaning the diffuser tubes such as, for example, using ultrasonic baths filled with cleaning solutions, are extremely difficult and time consuming. The cleaning of these tubes must be performed on a regular basis and can cause physical damage to the tubes. To avoid these issues, the diffuser tubes are typically replaced once they become clogged rather than cleaned. This increases the overall cost to the end-user.

Accordingly, in order to promote the application of inerting by N₂ and/or other inerting gases in wave soldering, it is desirable that the apparatus, method, or both fulfill at least one or more of the following objectives. First, it is desirable that the inerting apparatus and method reduces N₂ or other inerting gas consumption such as, but not limited to, 12 cubic meters per hour (m³/hr) or less to meet the cost benefits of applying the technology. Second, it is desirable that the inerting apparatus and method reduces the concentration of O₂ above the molten solder surface such as, but not limited to, 2500 parts per million (ppm) or less. Third, it is desirable that the inerting apparatus and method uses an apparatus that is simple to install and maintain to minimize retrofitting cost. Moreover, it is desirable that the apparatus or method reduces or eliminates the clogging of the porous diffuser tube to ensure a stable and long lasting inerting performance.

### BRIEF SUMMARY OF THE INVENTION

The apparatus and method described herein fulfills at least one or more of the above objectives for inerting using nitrogen and/or other inerting gases that may be more cost effective and user friendly than comparable methods and apparatuses presently in use.

In one embodiment, there is provided an apparatus for providing an inerting gas during soldering of a work piece comprising: at least one groove on a bottom surface of the apparatus for placing atop of at least one edge of a solder reservoir comprising molten solder; at least one opening on a top surface of the apparatus through which at least one solder wave emitting from the solder reservoir passes through and contacts the work piece as it travels on a moving track; and one or more diffuser tubes comprising one or more openings in fluid communication with an inerting gas source wherein the apparatus is positioned above the solder reservoir and underneath the work piece to be soldered thereby forming an atmosphere and wherein there is substantially no gap between the work piece to be soldered and an apex of the at least one solder wave. In one particular embodiment, the apparatus further comprises a disposable porous sheath surrounding at least part of the length of at least one of the one or more diffuser tubes. In some embodiments, at least one of the one or more diffuser tubes surrounded by the porous sheath is affixed to the bottom surface of the apparatus so that it is positioned within the atmosphere above the solder reservoir. In the same or other embodiments, an optional cover is placed atop of the apparatus through which the work piece travels therethrough wherein the cover further comprises a vent which is in communication with a ventilation system.

In another aspect, there is provided a method for providing an inerting gas atmosphere during wave soldering of a work piece comprising: providing a wave soldering machine comprising: a solder reservoir having molten solder contained therein, at least one nozzle, at least one pump to generate at least one solder wave from the molten solder bath upwardly through the nozzle; placing an apparatus atop at least one edge of the mouth of the solder reservoir wherein the apparatus comprises at least one opening on a top surface, at least one groove that rests atop the at least one edge of the solder reservoir, and one or more diffuser tubes comprising one or more openings in fluid communication with an inerting gas source, wherein at least part of the length of one of the one or more diffuser tubes is surrounded by a disposable porous sheath and wherein the work piece to be soldered and the top surface of the apparatus define an atmosphere and wherein there is substantially no gap between the work piece to be soldered and an apex of the at least one solder wave; passing a work piece along a path so that at least a portion of the work piece contacts the at least one solder wave emitting through the opening of the apparatus; and introducing an inerting gas through the diffuser tubes and into the atmosphere. In one particular embodiment, at least one of the one or more diffuser tubes surrounded by the disposable porous sheath is affixed to the bottom surface of the apparatus so that it is positioned within the atmosphere above the solder reservoir.

### BRIEF DESCRIPTION OF SEVERAL VIEWS OF THE DRAWINGS

FIG. 1 provides an isometric view of an embodiment of a diffuser tube comprising pores or a porous tube described herein.

FIGS. 2a through 2f provide bottom and cross-sectional views of embodiments of diffuser tubes described herein wherein the pores are in the form of one or more rows of longitudinal slots.

FIG. 3a provides a side view of one embodiment of the diffuser assembly described herein comprising a diffuser tube and a protective porous sheath surrounding at least part of the length of the diffuser tube.

FIG. 3b provides a cross-sectional view of the diffuser assembly shown in FIG. 3a.

FIG. 4a provides a top view of one embodiment of the apparatus described herein.

FIG. 4b provides a top view of another embodiment of the apparatus described herein.

FIG. 5 provides an isometric view of the embodiment of the apparatus depicted in FIG. 4a.

FIG. 6 provides an isometric view of an optional cover that can be installed atop of the moving track.

FIG. 7 provides an isometric view of an embodiment of the apparatus described herein.

FIG. 8 provides an isometric view of the embodiment depicted in FIG. 7 that further comprises a plurality of diffuser tubes (shown in dotted line) wherein at least one of the plurality of diffuser tubes further comprises a porous sheath surrounding at least part of the length of the diffuser tube.

FIG. 9 provides a side view of an embodiment of the apparatus for N₂ inerting described herein.

FIG. 10 provides a side view of an embodiment of the apparatus for N₂ inerting described herein.

### DETAILED DESCRIPTION OF THE INVENTION

At least one or more of the objectives in the art are fulfilled by the method and apparatus described herein for inerting protection during soldering. The apparatus and method described herein provides inerting protection during soldering, particularly for those embodiments where significant movement and swirling of the solder during soldering of work pieces such as printed circuit boards and increased oxidation of its surface may occur. It is anticipated that the apparatus and method described herein can be used, for example, to retrofit an existing wave soldering machine. In certain embodiments, the apparatus described herein in operation is placed over the solder reservoir and under the moving track or other conveyance mechanism for transporting the work pieces to be soldered. In certain embodiments, there is substantially no gap between the work piece to be soldered and the apex of the at least one solder wave. In other embodiments, there is a gap between the work piece to be soldered and the apex of the at least one solder wave. The one or more diffuser tubes located within the apparatus are in fluid connection to an inerting gas source such as nitrogen, inert gas (e.g., helium, neon, argon, krypton, xenon, and combinations thereof), forming gas (e.g., mixture of nitrogen and hydrogen comprising up to 5% by weight of hydrogen), or combinations thereof to provide an inerting atmosphere. One objective of the apparatus and method described herein is a reduced concentration of oxygen (O₂) in the atmosphere defined by the work piece surface to be soldered and the surface of the molten solder contained within the solder reservoir such as, but not limited to, 2500 parts per million (ppm) or less.

The apparatus and method described herein is intended to be placed atop of a solder reservoir containing molten solder that is maintained at or above (e.g., up to 50° C.) the solder's melting point. The apparatus described herein has an internal volume that sets atop of the solder reservoir thereby defining an atmosphere between the work piece to be soldered that is conveyed in one direction on a moving track above the solder reservoir and the molten solder surface. In certain embodiments, the work pieces are supported by a moving track or conveyor fingers at side edges and the fingers pass through the solder wave(s). In other embodiments, the work pieces are supported on pallets, fixtures, or frames as they are conveyed through the wave soldering machine. The solder reservoir has one or more nozzles therein that project one or more solder waves that are generated by a solder pump. The solder pump is typically a variable speed pump that allows the end user to control the flow of solder from the solder wave(s) and raise or lower the apex or crest of the solder wave(s) to suit processing conditions. The one or more solder waves contact the surface of the work piece to be soldered through one or more openings in the top surface of the apparatus described herein. During this process, the apparatus includes one or more diffuser tubes comprising one or more openings, apertures, slots, perforations, or pores that are in fluid communication with an inerting gas source such as N₂ that pass through the interior volume of the tube and out through the opening or pores of the tubes into the atmosphere. In doing so, the under surface, front edge, back edge and side edges of the work piece are uniformly blanketed by the inerting gas as the work piece passes through the solder wave(s).

In certain embodiment of the apparatus and method described herein, the size of the apparatus placed atop the solder reservoir is minimized to intensify the inerting efficiency around the moving solder waves. In this or other embodiments, the static molten solder surface, or area outside of the footprint of the apparatus in the solder reservoir, can be covered by a high temperature material that can withstand the temperature of the molten solder contained within the solder reservoir.

The apparatus and method described herein comprises one or more diffuser tubes comprising an interior volume and one or more openings which can be, but are not limited to, pores, holes, slots, vents, apertures, perforations or other means that allow for the passage of nitrogen and/or other inerting gas within the interior volume of the tube and out through the openings of the tube. The openings may be arranged in one or more lines, may be staggered, or may have any other regular or random arrangement. The openings may be of any suitable size to provide a sufficient flow of inerting gas, and their size may vary based upon a variety of factors, including the flow rate of inerting gas, the size of the interior volume to be inerted, and the dimensions of the diffuser tube, among others. In one particular embodiment, the tubes are porous and comprise an average pore size of about 0.05 to about 0.5 microns (μm), preferably about 0.2 microns, to provide a laminar flow of inerting or N₂ gas out of the porous tube. In another embodiment, the tubes comprise one or more parallel rows of slots to provide a laminar flow of inerting or N₂ gas out of the diffuser tube. For example, the openings may be arranged in a line along the bottom of the diffuser tube, such that inerting gas flowing out through the openings is directed downward onto the top surface of the solder in the solder reservoir. In another embodiment, the openings may be arranged in two parallel lines offset from the bottom center line of the diffuser by from about 0 to 45° in each direction, or by about 30° in each direction, so as to direct inerting gas outward and down as it flows out from the diffuser tube into the atmosphere above the molten solder in the solder reservoir. In such embodiments, the lines of openings may be separated from one another by about 30° to about 120°, or by about 60° or about 90°. In certain embodiments, the openings may be slots each from about 0.3 to about 1.5 mm in length, preferably from about 0.5 to about 1.0 mm in length. The slots may be separated by from about 0.5 to about 5 mm, preferably by about 1 mm.

In these or other embodiments, the tubes are in fluid communication with an inerting gas source that supplies the inerting gas such as, for example, N₂ through the interior volume of the tube and out through the openings or pores of the tubes into the area defined by the surface of the molten solder in the reservoir and conveyed work pieces. Gas flow through the diffuser tube described herein may vary, but is typically in the range of from about 0.5 to about 8 m³/hr.

As previously mentioned, the apparatus described herein comprises a housing that contains an interior volume within which one or more diffuser tubes are located. In certain embodiments, the tubes may be located between the plurality of solder waves, at the board entrance side of the solder reservoir, at the work piece exit side of the solder reservoir, perpendicular to the direction of the solder wave, or combinations thereof. In these embodiments, there is substantially no gap between the surface of the work piece to be soldered and that of the solder waves. In certain embodiments, one or more of the tubes, such as those embodiments wherein one or more of the tubes resides between a plurality of soldering waves, may further comprise one or more disposable porous sheaths or tubes surrounding at least part of the length of the diffuser tube. The sheaths may be formed from any suitable non-hazardous (i.e., ROHS-compliant) material that allows for periodic, simple, and cost-effective removal and replacement of the sheaths as they become coated or clogged with molten solder and/or flux residue during normal operation. For example, the sheaths may comprise a woven fiberglass or fiberglass-type material, alone or in combination with other compositions. In these or other embodiments, the sheath material selected should maintain its integrity at or above the molten solder temperature commonly used in lead-free wave soldering process (e.g., up to about 260° C.). In certain embodiments, at least one of the one or more diffuser tubes surrounded by the porous sheath is affixed to the bottom surface of the apparatus so that it is positioned within the atmosphere above the solder reservoir. The use of one or more disposable porous sheaths to surround at least a portion of the length of the diffuser tube protects the diffuser tube and avoids the problems associated in the prior art with solder splashing, immersion, and/or contacting the diffuser tube with the solder bath. In certain embodiments comprising a center diffuser tube and one or more side diffuser tubes, only the center diffuser tube is at least partially surrounded by a porous sheath as described herein. In alternative embodiments, the center diffuser and one or more of the side diffusers are at least partially surrounded by a porous sheath as described herein.

In one particular embodiment of the apparatus and method described herein, one or more of the plurality of diffuser tubes, such as, but not limited to, the center diffuser tube in between a plurality of solder waves, and/or one or more of the protective sheaths surrounding at least part of such diffuser tubes may comprise a non-stick coating. An example of a non-stick coating is polytetrafluoroethylene (PTFE) coating, which may be found under the trademark Teflon® non-stick coating (Teflon is manufactured by DuPont, Inc. of Wilmington Del.). In these or other embodiments, the non-stick coating selected should maintain its integrity at or above the molten solder's temperature commonly used in lead-free wave soldering process (e.g., up to about 260° C.). In a more particular embodiment, the non-stick coating is comprised of Thermolon™ non-stick coating, an inorganic (mineral based) coating which is manufactured by Thermolon Ltd. of South Korea, and which can maintain its integrity at 450° C. and avoids generating toxic vapor at elevated temperatures. In embodiment wherein the center porous tube resides between one or more pairs of soldering waves, the dissolved flux in the solder reservoir can directly contact the center diffuser surface located between the 1^{st} and the 2^{nd} waves due to a continual dynamic movement of the molten solder. When the liquid flux on diffuser surface is evaporated or thermally decomposed, solid flux residue may be left on the diffuser surface, thus causing diffuser clogging. To remedy this, a non-stick coating or a porous sleeve or sheath or a slotted metal shell coated with a non-stick coating may be applied to the diffuser tube or may cover at least a portion of the diffuser tube. It is believed that the addition of a non-stick coating, or a porous sheath, or a slotted metal shell coated with a non-stick coating to at least one of the porous diffuser tubes may prevent the clogging of the porous tube such as the center tube by solid flux residue. The non-stick coating can also be applied to at least a portion of the internal surface of the apparatus or the internal surface of the top cover, to allow for ease of cleaning.

In yet another embodiment of the apparatus and method described herein, the apparatus further comprises an optional cover mounted on the moving track thereby forming a tunnel for the work pieces to pass therethrough. The optional cover further comprises a ventilation hole that is in fluid communication with the ventilation exhaust of the wave soldering machine that allows for the collection of flux vapor from the atmosphere underneath the cover. In one embodiment, the optional cover is made of a single layer metal cover with a center hole connected to the ventilation exhaust of the machine. In another embodiment, the optional cover is made of double layer metal sheets, and the double layer space is connected to the furnace ventilation exhaust, thus forming a boundary gas trap. In one particular embodiment, the distance between the two layers of metal sheets can range from about ⅛″ to about ¼″. When a work piece or circuit board is passing underneath the cover, flux vapor generated inside the soldering area can be collected through the boundary trap, while air surrounding the solder reservoir can also be trapped in the double layer space, thereby ensuring good inerting performance. For the case when there is no work piece or circuit board on top of the solder reservoir, the inerting gas generated from the plurality of diffusers in the inerting apparatus can be sucked into volume underneath the double layer space of the cover, thereby forming a boundary inerting gas curtain to minimize air from entering into the volume.

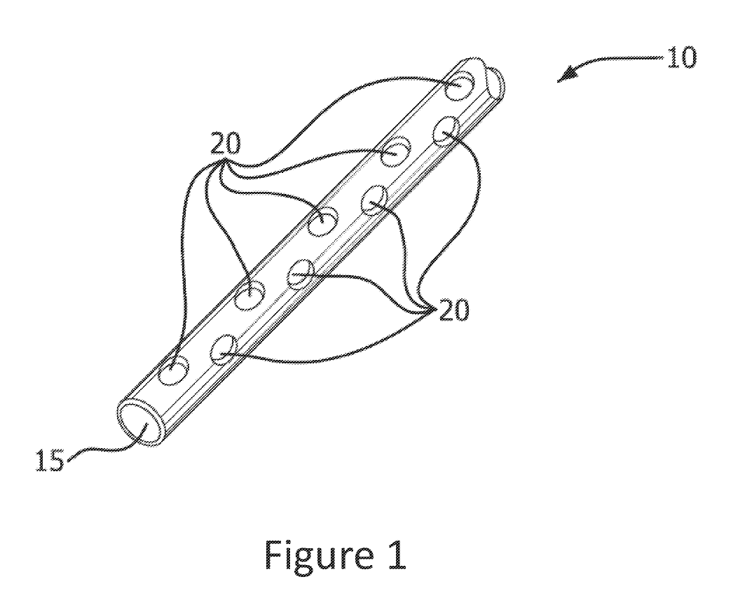

FIG. 1 provides one embodiment of the porous tube or diffuser that is used in the apparatus and method described herein. Porous tube 10 is depicted as being cylindrical tube which has an internal volume 15 that allows for the flow of an inerting gas such as nitrogen and/or other gas such as, but not limited to, inert gas (e.g., argon, helium, neon, etc.), hydrogen, or combinations thereof, to flow therethrough and is in fluid communication with an inerting gas source (not shown). In one embodiment of porous tube 10, porous tube is made of stainless steel. However, other materials for porous tube 10 may also be applicable as long as the materials are not reactive to the solder material. Porous tube 10 is in fluid communication with the inerting gas source through a gaseous conduit or other means (not shown). Porous tube 10 further comprises a plurality of perforations 20, pores, slots, or holes that allow for the flow of gas from the internal volume 15 through perforations 20 into the soldering bath atmosphere defined by the surface of the molten solder (not shown) and underside of the work piece to be soldered (not shown), or combinations thereof. While porous tube 10 is shown as being cylindrical and having a circular cross-sectional, it is anticipated that other geometries, such as, but not limited to, annular, square, rectangular, elliptical, etc. may be used.

Perforations 20 are designed so that gas flow is either narrowly directed, for example, with circular holes as shown in the embodiment of FIG. 1 and distributed over the entire length of the soldering reservoir (not shown). In another embodiment, perforations 20 can be longitudinal holes or slots. In these or other embodiments, perforations 20 may be chamfered or angled to further direct the flow of gas from the internal volume 15 into the soldering bath atmosphere (not shown) and/or gap between solder bath and work piece. The average size for perforations 20 may range from 0.05 micron to 100 micron, or from 0.1 to 10 micron, or from 0.2 to 5.0 micron. The perforation size and porosity of the perforations on porous tube 10 are optimized to pursue a laminar flow of gaseous N₂ out of the porous tube. In these or other embodiments, a laminar flow of N₂ and/or other inerting gas is preferred for minimizing air intruding from boundaries of the soldering area (e.g., work piece, conveyor belt, etc.) to be inerted.

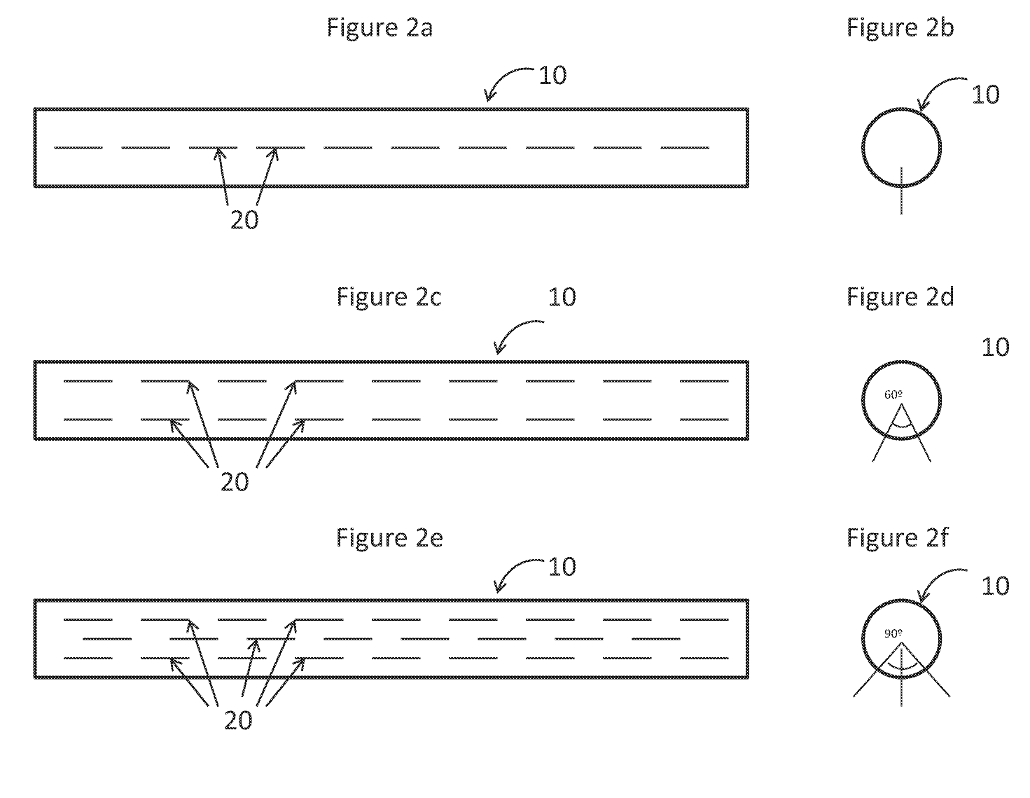

FIGS. 2a, b, c, d, e, and f further illustrate diffuser configurations in which the perforations 20 are in the form of one or more rows of longitudinal holes or slots. FIGS. 2a-f illustrate such configurations by providing views looking up at diffuser tube 10 from the direction of the solder reservoir (not shown, FIGS. 2a, 2c, and 2e) and looking at diffuser tube 10 from the end (FIGS. 2b, 2d, and 2f). As shown in FIGS. 2a and b, perforations 20 are arranged in a straight line along the bottom center line of the diffuser tube 10. In an alternative embodiment depicted in FIGS. 2c and d, the perforations 20 are arranged in two rows at 60° to the bottom center line of the diffuser tube 10. In a further alternative embodiment depicted in FIGS. 2e and f, the perforations 20 are arranged in three rows spaced equally from one another spanning the bottom center line of the diffuser tube 10 with 90° between the two outermost rows.

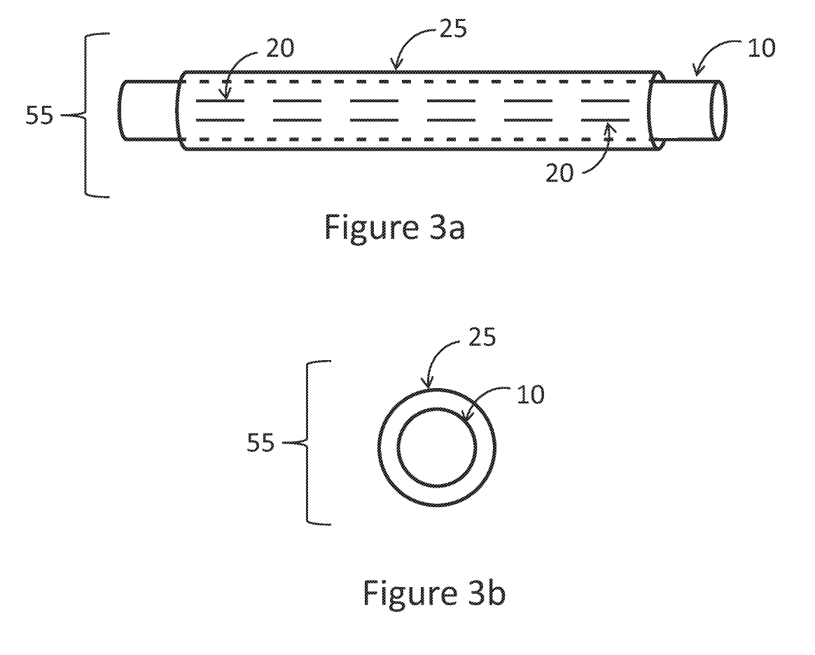

In some embodiments of the present invention, at least one of the one or more diffuser tubes, such as, but not limited to, the center diffuser tube between a plurality of solder waves, can further comprise a protective covering or sheath that surrounds at least a portion of the length of the diffuser tube. An example of such an embodiment is provided in FIGS. 3a (side view) and 3b (cross-sectional view). In this embodiment, diffuser tube 10 has one or more slots 20 and is surrounded over most of its length by a concentric sheath 25. The diffuser tube 10 and sheath 25 together form a diffuser assembly 55. The sheath 25 is porous to allow for the passage of an inerting gas from the perforations 20 in diffuser 10, through the sheath 25, and out into the inert atmosphere. It is believed that the use of such a protective sheath can minimize the chance of liquid solder or flux residue getting into the diffuser tube 10 and clogging the one or more openings 20. While liquid solder or flux residue may contaminate the sheath 25, the sheath is designed to be disposable in nature and easily removed and replaced periodically as such contamination occurs. Accordingly, any suitable non-flammable material may be used to form the sheath, provided that such material can withstand the required operating temperatures (such as up to about 600° C.) and allows for simple and cost effective disposal and replacement as described herein. In certain embodiments, sheath 25 is formed from a material comprising woven fiberglass yarns such that the porosity of the woven material is great enough to allow smooth flow of inerting gas from the diffuser tube 10, through the sheath 25, and out into the inert atmosphere. The inner diameter of the sheath 25 should be chosen based upon the outer diameter of the diffuser tube 10 so as not to impede the flow of the inerting gas. For example, in one embodiment in which the diffuser tube has an outer diameter of about 9.5 mm, the sheath may have an inner diameter of about 10 mm. Further, the sheath 25 may be held in place or affixed to the diffuser tube 10 by any suitable means. In one or more embodiments, the sheath 25 may be attached to the diffuser tube 10 by one or more jump rings, split rings, locking rings, clips, clamps, hooks, or the like (not shown). While diffuser tube 10 and sheath 25 are shown as being cylindrical and having a circular cross-sectional, it is anticipated that other geometries, such as, but not limited to, annular, square, rectangular, elliptical, etc., may be used.

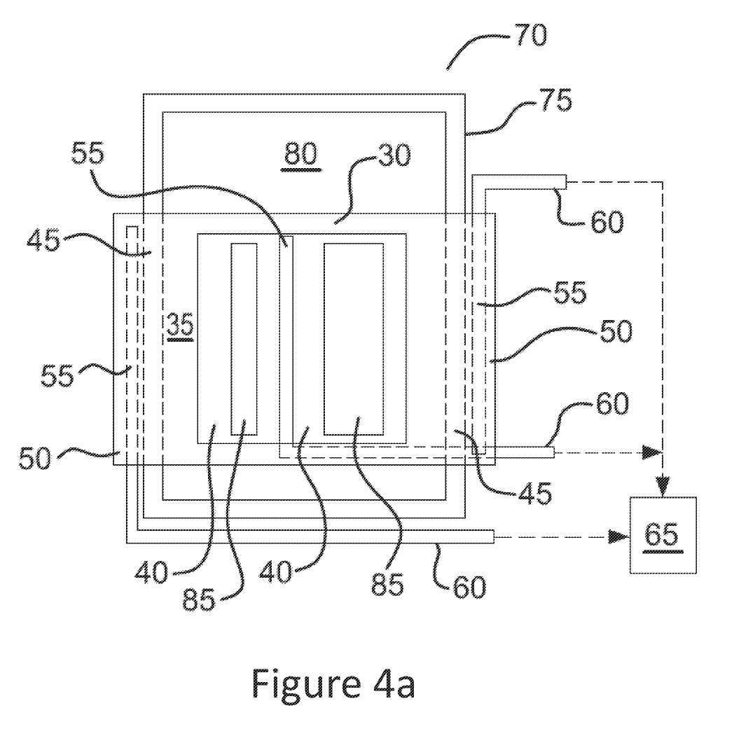

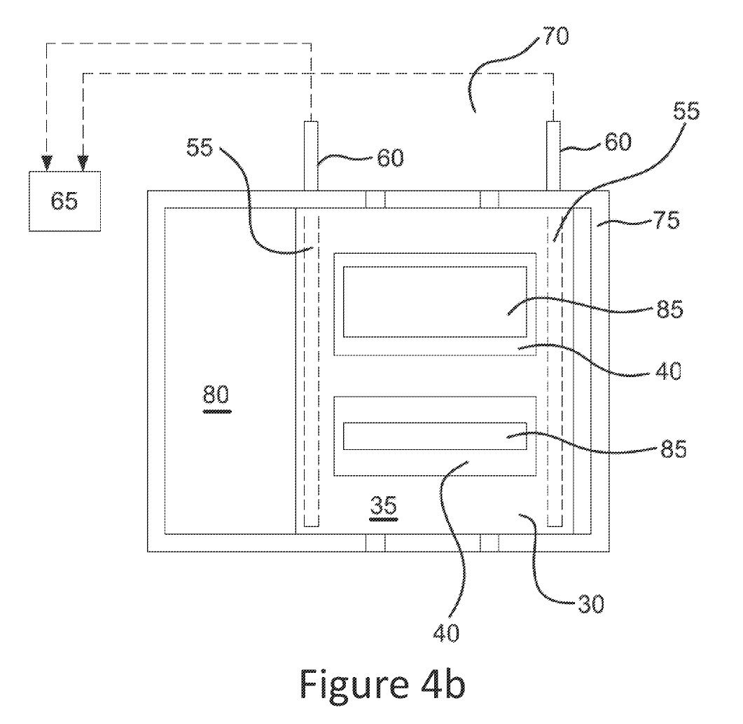

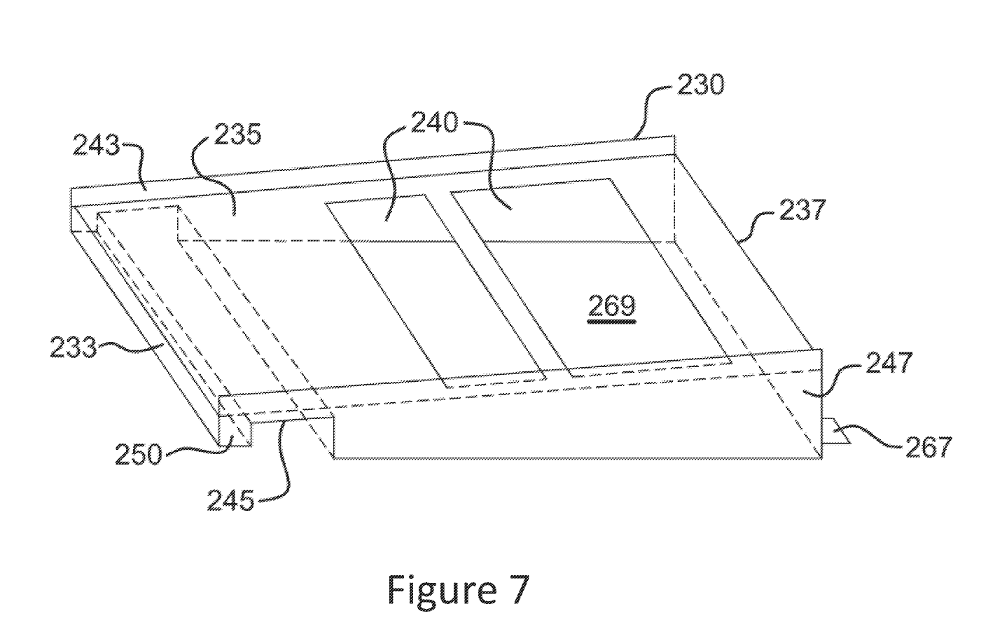

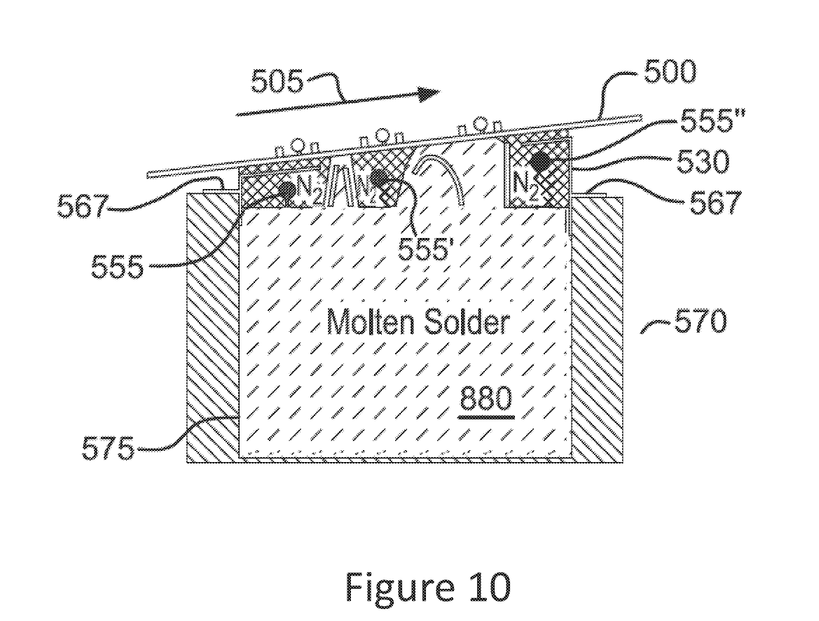

FIGS. 4a and 4b provide top views of embodiments of the apparatus 30 described herein. Referring to FIG. 4a, apparatus 30 is placed onto wave soldering apparatus 70 to provide an inerting gas atmosphere during a wave soldering operation. Wave soldering apparatus 70 comprises a solder reservoir 75 that contains a molten solder 80, and one or more nozzles 85 that project one or more solder waves (not shown) that are generated by a solder pump (not shown). Referring to both FIGS. 4a and 4b, apparatus 30 has a top surface 35 which may be removable from the rest of the apparatus thereby making dross removal relatively easy for the end-user. Top surface 35 further comprises at least one opening 40 through which at least one solder wave emitting from molten solder 80 contained within the solder reservoir 75 passes through nozzles 85 and contacts a work piece that passes through along a moving track (not shown). Referring to FIGS. 4a and 4b, apparatus 30 further comprises at least one groove 45 on the bottom of apparatus 30 (shown in dotted line in FIG. 4a) that rests atop of an edge of solder reservoir 75. In certain embodiments, apparatus 30 may comprise more than one groove that allow for the placement of apparatus 30 atop of solder reservoir 75 as shown in FIGS. 4a and 4b. Other embodiments of the apparatus described herein have only one groove 45 such as the embodiment depicted in FIGS. 7 through 9. Still further embodiments of the apparatus described herein do not have one or more grooves but rather a plurality of flanges that allow the apparatus to be positioned or placed on solder reservoir such as the embodiments depicted in FIG. 10. Referring again to FIGS. 4a and 4b, diffuser assembly 55 is in fluid communication via piping 60 to an inerting gas source 65. As previously mentioned, the inerting gas used with the apparatus and method described herein may comprise nitrogen, hydrogen, an inert gas (e.g., helium, argon, neon, krypton, xenon, etc.), or combinations thereof. In certain embodiments, the inerting gas is pre-heated prior to being introduced into diffuser assembly 55. It is understood that the embodiments shown in FIGS. 4a and 4b may vary depending upon the configuration of the wave soldering machine. For example, while FIG. 4a depicts diffuser assemblies 55 oriented parallel to the width of the solder wave, FIG. 4b provides a top view of an embodiment of the apparatus 30 described herein wherein diffuser assemblies 55 are oriented perpendicular to the width of the solder wave. In these and other embodiments, the diffuser assemblies may be affixed to the bottom surface of the apparatus 30. The diffuser assemblies 55 may be affixed to the apparatus 30 in any orientation and by any suitable manner of attachment, such as for example by screws, nuts, bolts, clips, clamps, hooks, and the like.

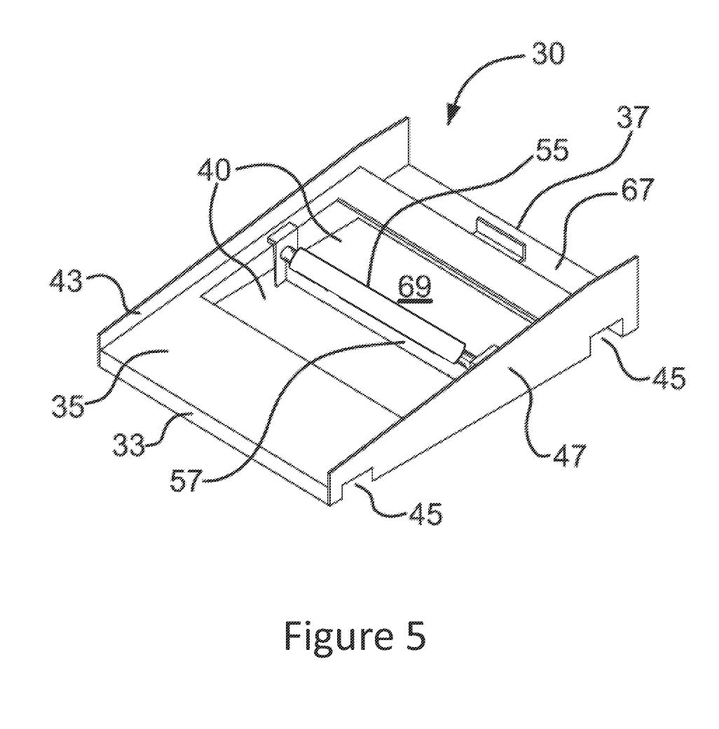

FIG. 5 provides an isometric view of an embodiment of the apparatus 30 described herein. As shown in FIG. 5, apparatus 30 further comprises an interior volume 69 defined by the molten solder surface (not shown), the work piece (not shown), front wall 33, back wall 37, and side walls 43 and 47.

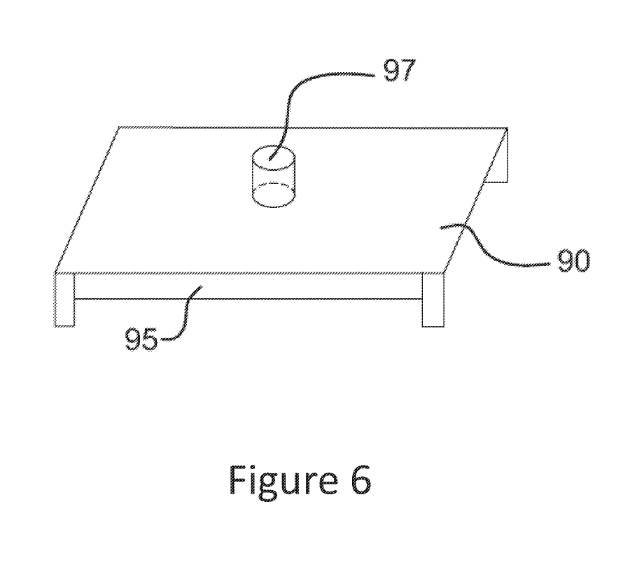

FIG. 6 provides an isometric view of optional cover 90 that is placed over the apparatus 30 and moving track (not shown) such that the work piece travels therethrough. Optional cover 90 is shown having a glass window 95 that allows for viewing. Optional cover 90 further has a vent 97 that is in fluid communication with the ventilation exhaust (not shown) of the wave soldering machine to remove any flux vapor within the atmosphere of the soldering station.

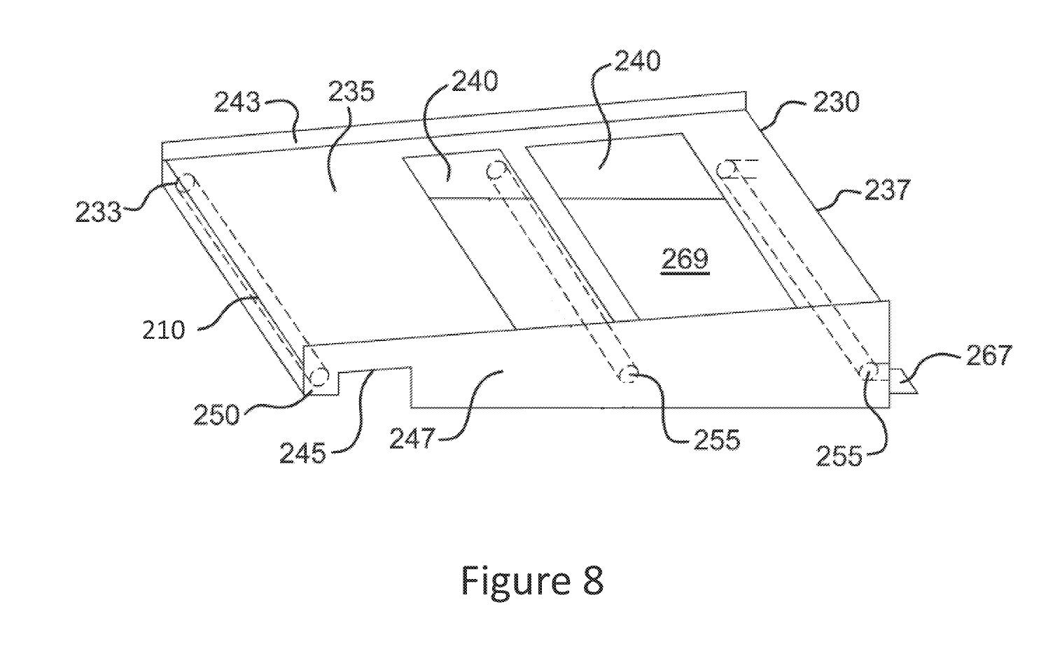

FIGS. 7 and 8 provide an alternative embodiment of apparatus 230 wherein there is only one groove 245 that rests upon the edge of solder reservoir (not shown). At least one of the sidewalls of groove 245 and the front wall 233 of apparatus 230 define a chamber 250 that contains diffuser tube 210 (shown in dotted line on FIG. 8). Apparatus 230 further comprises an interior volume 269 defined by the molten solder surface (not shown), the work piece (not shown), front wall 233, back wall 237, and side walls 243 and 247. Referring to FIG. 8, apparatus 230 further comprises at least one diffuser assembly 255 (shown in dotted line) affixed to the bottom surface of the apparatus 230.

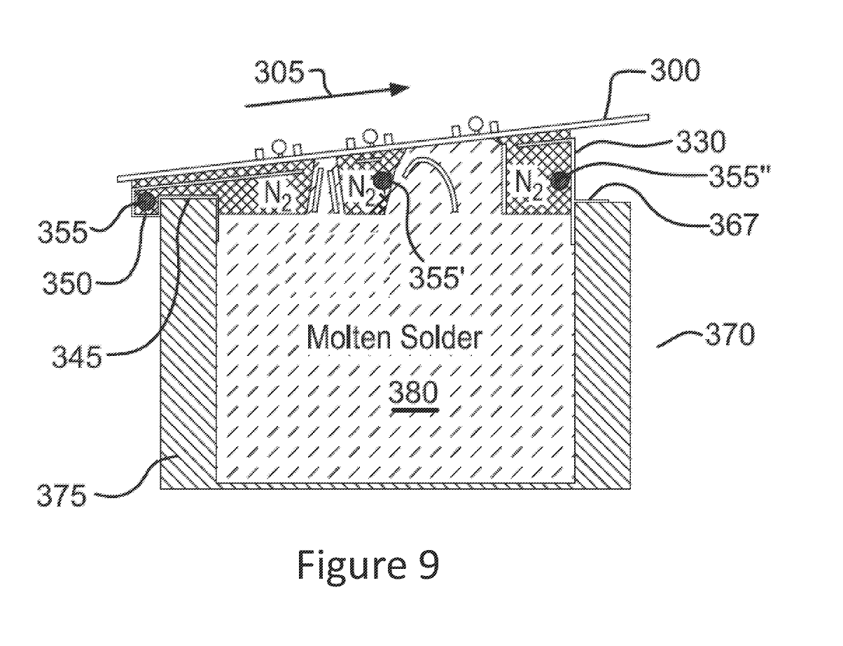

FIGS. 9 and 10 provide various embodiments of the apparatus described herein comprising a plurality of porous diffuser tubes and/or diffuser assemblies. FIG. 9 provides an embodiment wherein one of the diffuser tubes 310 is located outside the solder reservoir 375 in cavity 350, a diffuser assembly 355′ between the solder waves comprises a diffuser tube surrounded over at least a portion of its length by a protective porous sheath (not individually shown), and a second diffuser assembly 355″ is affixed to the bottom surface or the wall of the apparatus 330. Apparatus 330 further contains a flange 367 which aids in positioning apparatus 330 atop of solder reservoir 375.

FIG. 10 provides an embodiment wherein a first diffuser assembly 555, second diffuser assembly 555′, and third diffuser assembly 555″ are located within the inert atmosphere inside the solder reservoir 575, and each diffuser assembly comprises a diffuser tube surrounded over at least a portion of its length by a protective porous sheath (not individually shown). Apparatus 530 does not have grooves to position the apparatus atop of solder reservoir 575. Instead, apparatus 530 has a plurality of flanges 567 that allow apparatus 530 to be placed atop of solder reservoir 575.

Further benefits of apparatuses and methods according to the present invention include reduction in manufacturing and material costs, improved solder joint quality, and simplified transition to lead-free soldering technology. With regard to manufacturing and material costs, reductions of 20-40% in solder consumption, 40-90% in dross formation, 10-30% in flux consumption, and 70-80% in equipment maintenance have been observed, along with lower costs for post assembly board cleaning, reduced board defects and reworking, and higher productivity uptime. A further benefit of the apparatuses disclosed herein is that they can easily be scaled up or down and can be configured to fit solder pots having a variety of different dimensions.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application for all jurisdictions in which such incorporation is permitted.

Certain embodiments and features of the invention have been described using a set of numerical upper limits and a set of numerical lower limits. For the sake of brevity, only certain ranges are explicitly disclosed herein. However, it should be appreciated that ranges from any lower limit to any upper limit are contemplated unless otherwise indicated. Similarly, ranges from any lower limit may be combined with any other lower limit to recite a range not explicitly recited, and ranges from any upper limit may be combined with any other upper limit to recite a range not explicitly recited. Further, a range includes every point or individual value between its end points even though not explicitly recited. Thus, every point or individual value may serve as its own lower or upper limit combined with any other point or individual value or any other lower or upper limit, to recite a range not explicitly recited. All numerical values are “about” or “approximately” the indicated value, and take into account experimental error and variations that would be expected by a person having ordinary skill in the art.

While the foregoing is directed to embodiments of the invention and alternate embodiments thereof, various changes, modifications, and alterations from the invention may be contemplated by those skilled in the art without departing from the intended spirit and scope thereof. It is intended that the present invention only be limited by the terms of the appended claims.

1. An apparatus for providing an inerting gas during soldering of a work piece, the apparatus comprising:
at least one groove on a bottom of the apparatus for placing onto at least one edge of a solder reservoir having molten solder contained therein;
at least one opening on the top surface of the apparatus through which at least one solder wave emitting from the solder reservoir passes through and contacts the work piece; and
one or more diffuser tubes comprising one or more openings in fluid communication with an inerting gas source and one or more porous sheaths surrounding at least a portion of the length of at least one of the one or more diffuser tubes, wherein each diffuser tube and surrounding porous sheath together comprise a diffuser assembly;
wherein the apparatus is positioned above the solder reservoir and underneath the work piece to be soldered thereby forming an atmosphere and wherein there is substantially no gap between the work piece to be soldered and the apex of the at least one solder wave.

2. The apparatus of claim 1, wherein the porous sheath comprises a woven material.

3. (canceled)

4. The apparatus of claim 2 wherein at least one diffuser assembly resides proximal to the at least one solder wave.

5. The apparatus of claim 1 further comprising a cover that is placed atop of the moving track whereby the work piece travels therethrough wherein the cover further comprises a vent which is in communication with a ventilation system.

6. The apparatus of claim 5 wherein the cover comprises a plurality of sheets that define an interior volume and wherein the interior volume is in fluid communication with the ventilation exhaust of a soldering furnace.

7. The apparatus of claim 6 wherein the cover further comprises an inlet in fluid communication with the inerting gas source.

8. The apparatus of claim 1 wherein the openings in the diffuser tubes are longitudinal slots arranged in one or more parallel rows along the length of the diffuser tube.

9. The apparatus of claim 1 wherein at least one diffuser assembly is affixed to the bottom surface of the apparatus.

10. The apparatus of claim 1 wherein the solder reservoir generates a plurality of solder waves and at least one diffuser assembly is interposed between the solder waves.

11-12. (canceled)

13. The apparatus of claim 1 wherein the inerting gas comprises a gas selected from the group consisting of nitrogen, hydrogen, helium, neon, argon, krypton, xenon, and combinations thereof.

14. A method for providing an inerting gas atmosphere during wave soldering of a work piece, the method comprising:
providing a wave soldering machine comprising: a solder reservoir having molten solder contained therein, at least one nozzle, at least one pump to generate at least one solder wave from the molten solder bath upwardly through the nozzle; placing an apparatus atop at least one edge of the solder reservoir wherein the apparatus comprises at least one opening on a top surface, at least one groove that rests atop the at least one edge of the solder reservoir, one or more diffuser tubes comprising one or more openings in fluid communication with an inerting gas source, and one or more porous sheaths surrounding at least a portion of the length of at least one of the one or more diffuser tubes, wherein the work piece to be soldered and the top surface of the molten solder define an atmosphere and wherein there is substantially no gap between the work piece to be soldered and the apex of the at least one solder wave;
passing a work piece along a path so that at least a portion of the work piece contacts the at least one solder wave emitting through the opening of the apparatus; and
introducing an inerting gas through the diffuser tubes and into the atmosphere,
wherein each diffuser tube and surrounding porous sheath together comprise a diffuser assembly.

15. (canceled)

16. The method of claim 14 wherein at least one diffuser assembly resides proximal to the at least one solder wave.

17. The method of claim 14 further comprising a cover that the work piece travels therethrough wherein the cover further comprises a vent which is in communication with a ventilation system.

18. The method of claim 17 wherein the cover comprises a plurality of sheets that define an interior volume and wherein the interior volume is in fluid communication with the ventilation exhaust of a soldering furnace.

19. The method of claim 18 wherein the cover further comprises an inlet in fluid communication with the inerting gas source.

20. The method of claim 14 wherein the openings in the diffuser tubes are longitudinal slots arranged in one or more parallel rows along the length of the diffuser tube.

21. The method of claim 14 wherein at least one diffuser assembly is affixed to the bottom surface of the apparatus.

22. The method of claim 14 wherein the solder reservoir generates a plurality of solder waves and at least one diffuser assembly is interposed between the solder waves.

23-24. (canceled)

25. The method of claim 14 wherein the inerting gas comprises a gas selected from the group consisting of nitrogen, hydrogen, helium, neon, argon, krypton, xenon, and combinations thereof.

26. The method of claim 14 further comprising the steps of:
removing at least one of the porous sheaths surrounding at least a portion of the length of one of the diffuser tubes; and
replacing the porous sheath with a new porous sheath.
